(19) United States
(12) Patent Application Publication
(10) Pub. No.: US 2023/0018240 A1
(43) Pub. Date: Jan. 19, 2023

(54) DISPLAY DEVICE

(71) Applicant: Panasonic Intellectual Property Management Co., Ltd., Osaka (JP)

(72) Inventors: Ken'ichi KASAZUMI, Osaka (JP); Toshiya MORI, Osaka (JP)

(73) Assignee: Panasonic Intellectual Property Management Co., Ltd., Osaka (JP)

(21) Appl. No.: 17/953,777

(22) Filed: Sep. 27, 2022

Related U.S. Application Data
(63) Continuation of application No. PCT/JP2021/000894, filed on Jan. 13, 2021.

(30) Foreign Application Priority Data
Mar. 31, 2020 (JP) 2020-062530

(51) Int. Cl. F21V 8/00; G02B 27/01; B60K 35/00

(52) U.S. Cl. CPC G02B 6/0045; G02B 27/0103; B60K 35/00; G02B 2027/0118; B60K 2370/336; B60K 2370/1529

(57) ABSTRACT

A display device includes a light guide body and displays an image of light emitted from the light guide body. The light guide body is of a curved shape, and includes a light guide plate and an optical element that diffracts and emits light propagating inside the light guide plate. The optical element is provided in the light guide body so that the angle of the optical element relative to a propagation direction in which the light propagates inside the light guide plate is constant irrespective of where in the optical element.

### CROSS REFERENCE TO RELATED APPLICATIONS

This is a continuation application of PCT International Application No. PCT/JP2021/000894 filed on Jan. 13, 2021, designating the United States of America, which is based on and claims priority of Japanese Patent Application No. 2020-062530 filed on Mar. 31, 2020.

### FIELD

The present disclosure relates to display devices.

### BACKGROUND

Patent Literature (PTL) 1 discloses a display device that includes: a light source that emits light; a display element that modulates the light emitted from the light source, to display a video; a light guide member including flat planes that are two planes facing each other and parallel to each other; and a plurality of holographic diffractive optical elements of volume phase type that are held at different locations on the planes of the light guide member. The light guide member and the holographic diffractive optical elements in the display device each have a flat shape.

### CITATION LIST

### Patent Literature

PTL 1: Japanese Unexamined Patent Application Publication No. 2007-219106

### SUMMARY

However, a display device according to PTL 1 can be improved upon.

In view of this, the present disclosure provides a display device capable of improving upon the above related art.

A display device according to one aspect of the present disclosure includes a light guide body and displays an image of light emitted from the light guide body. The light guide body is of a curved shape, and includes a light guide plate and an optical element that diffracts and emits light propagating inside the light guide plate. The optical element is provided in the light guide body so that an angle of the optical element relative to a propagation direction in which the light propagates inside the light guide plate is constant irrespective of where in the optical element.

Note that one or more specific aspects of the features described above may be implemented using a system, a method, an integrated circuit, a computer program, or a computer-readable recording medium such as a CD-ROM, or any combination thereof.

The display device according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A is a schematic diagram illustrating a display device according to an embodiment and a vehicle when viewed from the side.

FIG. 1B is a cross-sectional view of a light guide body in a display device according to a comparative example when viewed from the side.

FIG. 2 is a cross-sectional view of a light guide body in a display device according to Embodiment 1 when viewed from the side.

FIG. 3A is a cross-sectional view of the display device according to Embodiment 1 when viewed from the side.

FIG. 3B is a schematic diagram illustrating examples of the configuration of an image light emitter of the display device according to Embodiment 1.

FIG. 3C is an exploded perspective view of the display device according to Embodiment 1 which is disassembled.

FIG. 4 is a three-view drawing of the display device according to Embodiment 1.

FIG. 5A is a cross-sectional view of a display device according to Variation 1 of Embodiment 1 when viewed from the side.

FIG. 5B is a cross-sectional view of a display device according to Variation 2 of Embodiment 1 when viewed from the side.

FIG. 6 is a cross-sectional view of a display device according to Embodiment 2 when viewed from the side.

FIG. 7A is a cross-sectional view of a display device according to Variation 1 of Embodiment 2 when viewed from the side.

FIG. 7B is a cross-sectional view of a display device according to Variation 2 of Embodiment 2 when viewed from the side.

### DESCRIPTION OF EMBODIMENTS

With the display device according to PTL 1 mentioned above, outside light such as sunlight reflects off the surface of the light guide member and enters the eyes of a user, and the user may feel the light too bright. In view of this, it is conceivable, for example, that the light guide member is of a curved shape so that outside light that has reflected off the surface of the light guide member is less likely to enter the user's eyes. The curved shape of the light guide member, however, requires the holographic diffractive optical element to have a curved shape as well, and this makes it difficult to make such a holographic diffractive optical element with ease.

In view of this, the present disclosure provides a display device capable of inhibiting outside light from entering the eyes of a user and enabling easy making of an optical element.

Embodiments and so on described below each show a generic or specific example of the present disclosure. The numerical values, shapes, materials, elements, the arrangement and connection of the elements, steps, an order of the steps, etc., indicated in the following embodiments are mere examples, and therefore are not intended to limit the scope of the present disclosure. Among elements in the following embodiments, those not recited in any one of the independent claims are described as optional elements. Any of the aspects from one of the embodiments may be combined with any of the aspects from any other embodiment of the embodiments.

The drawings are presented schematically and are not necessarily precise illustrations. In addition, like components are assigned with like reference signs in the drawings. In the embodiments described below, the expression “approximately same” and so on are used. For example, “approximately same” does not only mean being completely same but also means being substantially same, allowing for a difference of a small percentage, for example. Moreover, “approximately same” means being same within a range in which the advantageous effects of the present disclosure can be achieved. The same applies to other expressions with “approximately”.

Hereinafter, a display system according to one aspect of the present disclosure will be described in detail with reference to the drawings.

### Embodiment 1

### <Brief Description>

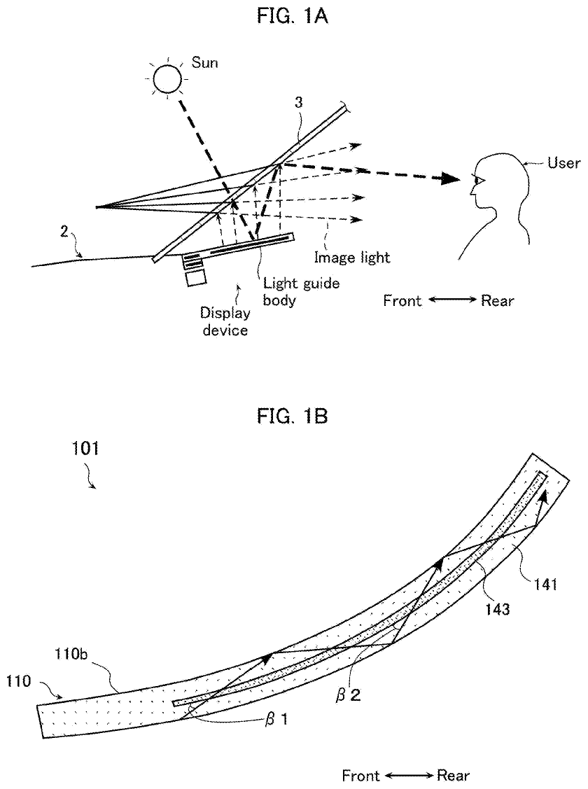

FIG. 1A is a schematic diagram illustrating a display device and vehicle 2 when viewed from the side. Note that a lateral direction in FIG. 1A is a lateral direction in the case where a direction in which a user who is a driver or a passenger faces is front, and is equivalent to a second direction which is to be described later.

As illustrated in FIG. 1A, the display device is disposed on, for example, the dashboard (also referred to as an instrument panel) of vehicle 2 such as an automobile. Front window 3 is disposed above the dashboard of vehicle 2. A light guide body in display device 1 is disposed between the dashboard and front window 3. Front window 3 is one example of a display medium.

With image light, which is emitted from the light guide body, reflecting off front window 3, the display device is capable of displaying an image of the image light to the user. In other words, the display device projects, at the front of front window 3, the image light emitted from the light guide body, to display the image presented by the image light to the user. The image light is light that presents information in an image including numerals, characters, graphics, etc., and is displayed as a virtual image at the front of front window 3. The image is a still or moving image and includes numerals, characters, graphics, etc.

According to the display device described above, since the light guide body has a flat shape, outside light such as sunlight reflects off the surface of the light guide body and enters the user's eyes, and the user may feel the light too bright. In view of this, a display device capable of inhibiting outside light that has reflected off the surface of the light guide body from entering the user's eyes is demanded.

The following describes a display device according to a comparative example.

FIG. 1B is a cross-sectional view of light guide body 110 in display device 101 according to the comparative example when viewed from the side.

Light guide body 110 in display device 101 according to the comparative example includes light guide plate 141 and optical element 143 that diffracts and emits light propagating inside light guide plate 141. Light guide body 110 has a curved shape when viewed along its lateral direction. Specifically, light guide body 110 according to the comparative example has a light-trap shape with different curvatures depending on the location on light guide body 110. Owing to such a shape, outside light that has reflected off surface 110b of light guide body 110 is directed to a location different from the location of the eyes of a user to inhibit the outside light from entering the user's eyes.

The curved shape of light guide body 110, however, requires optical element 143 to have a curved shape as well. With optical element 143 according to the comparative example, an angle at which light propagating inside light guide plate 141 enters optical element 143 varies (e.g., angle β1 or β2) depending on a location on optical element 143. It is therefore necessary, when making optical element 143, to process a material to be processed while concurrently changing a location on the material where an irradiation beam is irradiated and an angle of the irradiation beam, and it is thus not possible to make optical element 143 with ease.

In contrast, the display device according to the present embodiment has a configuration described below, in order to inhibit outside light from entering the user's eyes and enable easy making of an optical element.

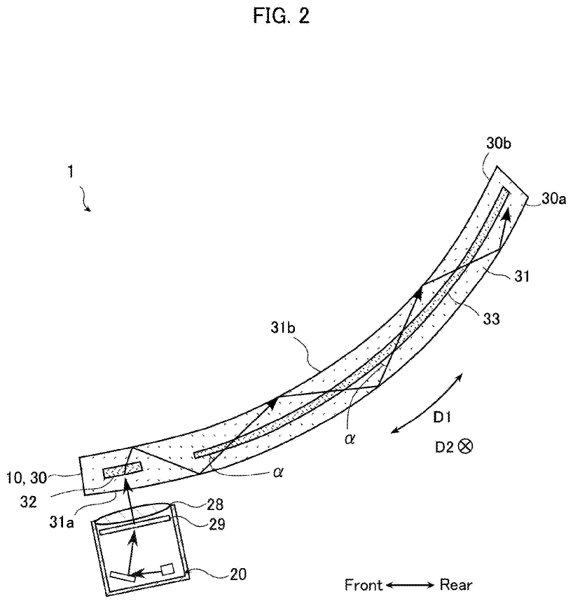

FIG. 2 is a cross-sectional view of light guide body 10 in display device 1 according to Embodiment 1 when viewed from the side.

As illustrated in FIG. 2, display device 1 includes image light emitter 20 and light guide body 10. Light guide body 10 includes light guide plate 31 and optical element 33 that diffracts and emits light propagating inside light guide plate 31.

Light guide body 10 has a curved shape when viewed along its lateral direction as in FIG. 2, and specifically, the cross section of light guide body 10 is arc-shaped. Optical element 33 is provided in light guide body 10 so that angle α of optical element 33 relative to a propagation direction (the direction of an arrow that intersects optical element 33) in which the light propagates inside light guide plate 31 is constant irrespective of where in optical element 33.

In other words, with display device 1 according to Embodiment 1, angle α at which the light propagating inside light guide plate 31 enters optical element 33 is same irrespective of where in optical element 33. Accordingly, in making optical element 33, it is possible to process a material to be processed while fixing an angle of an irradiation beam with which the material is irradiated and changing a location on the material where the irradiation beam is irradiated. This enables easy making of optical element 33.

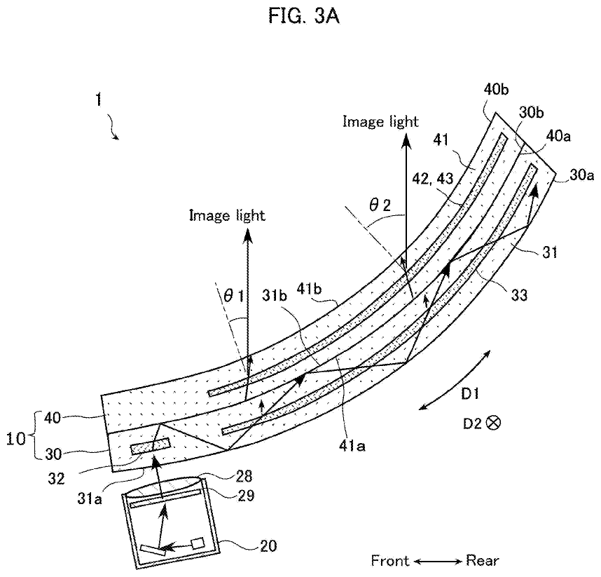

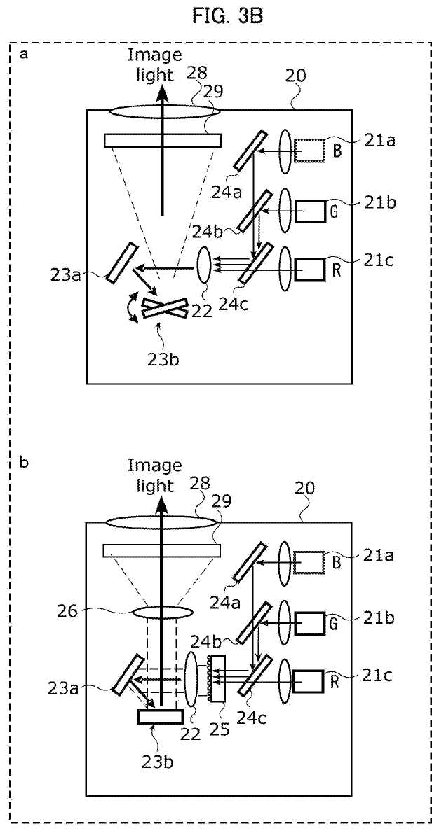

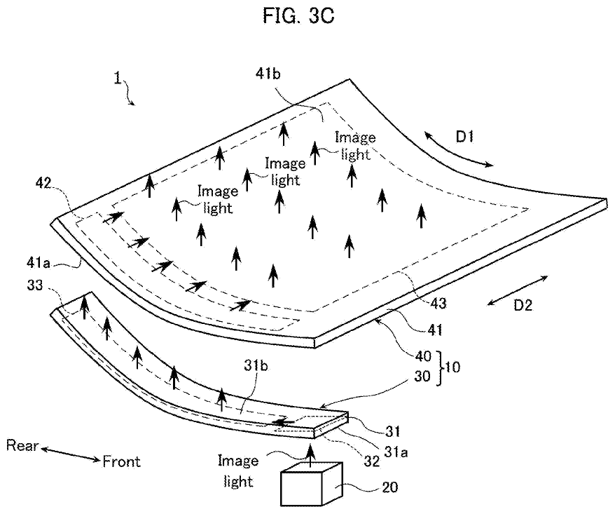

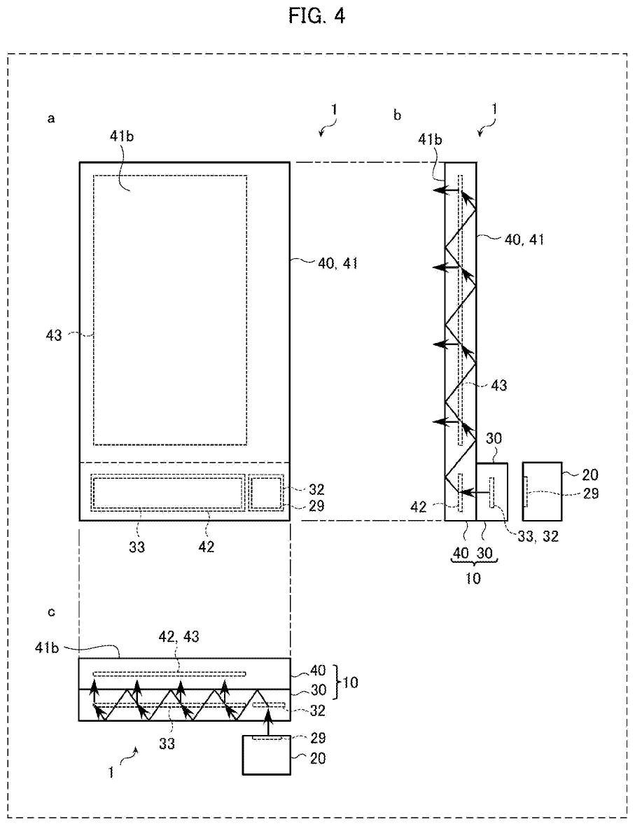

Display device 1 according to the present embodiment includes image light emitter 20 and light guide body 10 including first light guide body 30 and second light guide body 40. Hereinafter, image light emitter 20, first light guide body 30, and second light guide body 40 included in display device 1 according to the present embodiment will be described with reference to FIG. 3A through FIG. 4.

### <Image Light Emitter 20>

FIG. 3A is a cross-sectional view of a display device according to Embodiment 1 when viewed from the side.

Image light emitter 20 emits image light that presents an image so that the image light enters a light guide body. The image light is reflected by front window 3, as a result of which a virtual image is perceived. Image light emitter 20 emits the image light from emission surface portion 29. The image light emitted from emission surface portion 29 of image light emitter 20 enters and passes through first light guide body 30. After that, the image light enters and passes through second light guide body 40, and then is emitted therefrom, so that the image light is projected on front window 3.

FIG. 3B is a schematic diagram illustrating examples of the configuration of image light emitter 20 of display device 1 according to Embodiment 1. a in FIG. 3B illustrates the case of using micro electro mechanical system (MEMS) mirror as second mirror 23b for image light emitter 20. b in FIG. 3B illustrates the case of using digital light processing (DLP) as second mirror 23b for image light emitter 20.

As illustrated in FIG. 3B, image light emitter 20 includes first emitter 21a that emits a first light beam, second emitter 21b that emits a second light beam, third emitter 21c that emits a third light beam, a plurality of dichroic mirrors, condenser lens 22, first mirror 23a, second mirror 23b, and emission surface portion 29.

The wavelength of the first light beam, the wavelength of the second light beam, and the wavelength of the third light beam are different from each other. For example, the first light beam, the second light beam, and the third light beam are a first laser beam, a second laser beam, and a third laser beam, respectively. In the present embodiment, the first light beam is a blue light beam, the second light beam is a green light beam, and the third light beam is a red light beam. The red light beam is light having a wavelength range perceivable as red. The green light beam is light having a wavelength range perceivable as green. The blue light beam is light having a wavelength range perceivable as blue.

First emitter 21a, second emitter 21b, and third emitter 21c irradiate the plurality of dichroic mirrors with light beams in one-to-one correspondence.

The present embodiment describes the case of using first dichroic mirror 24a, second dichroic mirror 24b, and third dichroic mirror 24c as the plurality of dichroic mirrors.

First dichroic mirror 24a is disposed on the first light beam emitted by first emitter 21a. The first light beam is incident on first dichroic mirror 24a via a lens. First dichroic mirror 24a reflects the first light beam to guide the first light beam to second dichroic mirror 24b. In the present embodiment, first dichroic mirror 24a has a function to reflect a light beam having the wavelength range of a blue color and transmit a light beam having a different wavelength range (e.g., a green light beam or a red light beam).

Second dichroic mirror 24b is disposed on the second light beam emitted by second emitter 21b. The second light beam is incident on second dichroic mirror 24b via a lens, and the first light beam is incident on second dichroic mirror 24b from the first dichroic mirror 24a side. Second dichroic mirror 24b transmits the first light beam to guide the first light beam to third dichroic mirror 24c. In addition, second dichroic mirror 24b reflects the second light beam to guide the second light beam to third dichroic mirror 24c. In the present embodiment, second dichroic mirror 24b has a function to reflect a light beam having the wavelength range of a green color, and transmit a light beam having a different wavelength range (e.g., a blue light beam or a red light beam).

Third dichroic mirror 24c is disposed on the third light beam emitted by third emitter 21c. The third light beam is incident on third dichroic mirror 24c via a lens, and the first light beam and the second light beam are incident on third dichroic mirror 24c from the second dichroic mirror 24b side. Third dichroic mirror 24c transmits the third light beam to guide the third light beam to condenser lens 22. In addition, third dichroic mirror 24c reflects the second light beam and the third light beam to guide the second and third light beams to light condenser lens 22. In the present embodiment, third dichroic mirror 24c has a function to reflect a light beam having the wavelength range of a green color and a light beam having the wavelength range of a blue color, and transmit a light beam having a different wavelength range (e.g., a red light beam).

Note that digital light processing (DLP) may be used as second mirror 23b, as illustrated in b in FIG. 3B. In this case, micro-lens array 25 may be disposed between condenser lens 22 and third dichroic mirror 24c. Projection lens 26 may be disposed on the optical path between second mirror 23b and emission surface portion 29.

Condenser lens 22 is a lens that condenses, on first mirror 23a, the first light beam, the second light beam, and the third light beam which are emitted via third dichroic mirror 24c. Condenser lens 22 comprises glass, transparent resin, etc. In the present embodiment, condenser lens 22 is a convex lens, but may be a concave lens.

Condenser lens 22 is disposed on the emission direction side of the first light beam, the second light beam, and the third light beam which are emitted from third dichroic mirror 24c.

First mirror 23a reflects the first light beam, the second light beam, and the third light beam to guide these light beams to second mirror 23b.

Second mirror 23b reflects the first light beam, the second light beam, and the third light beam which are reflected by first mirror 23a, to irradiate emission surface portion 29 with the first light beam, the second light beam, and the third light beam. Second mirror 23b is, for example, a MEMS mirror, and is capable of changing, through rotation, the irradiation directions of the first light beam, the second light beam, and the third light beam.

Emission surface portion 29 is a screen of, for instance, a micro-lens array, or a liquid crystal display element such as a liquid crystal display (LCD). For example, emission surface portion 29 is a light-transmissive or light-translucent thin film transistor (TFT) liquid crystal display.

Image light, which is light transmitted as a result of the first light beam, the second light beam, and the third light beam being irradiated from the second mirror 23b side, is emitted from emission surface portion 29. Emission surface portion 29 drives together with first emitter 21a, second emitter 21b, and third emitter 21c by electric power obtained from the vehicle 2 side. Image light, which presents an image including numerals, characters, graphics, etc. and is in accordance with a control instruction from a controller mounted in vehicle 2 in FIG. 1A, is emitted from the emission surface of emission surface portion 29. The emission surface is a surface of emission surface portion 29 and faces first light guide body 30.

Emission surface portion 29 is supported by a case so that the emission surface of emission surface portion 29 faces first light guide body 30 and the rear surface of emission surface portion 29 faces second mirror 23b. Specifically, emission surface portion 29 is supported by the case so that the optical axis of the image light emitted from emission surface portion 29 and the optical axis of the image light reflected by second mirror 23b are substantially the same. The case is an accommodating body that accommodates first emitter 21a, second emitter 21b, third emitter 21c, the plurality of dichroic mirrors, condenser lens 22, first mirror 23a, second mirror 23b, emission surface portion 29, etc., and is accommodated in the dashboard of vehicle 2. In the present embodiment, telecentric lens 28 is disposed on the image light emission side of emission surface portion 29. The image light emitted from emission surface portion 29 is incident on first incident surface 31a via telecentric lens 28.

### <First Light Guide Body 30>

FIG. 3C is an exploded perspective view of display device 1 according to Embodiment 1 which is disassembled. FIG. 4 is a three-view drawing of display device 1 according to Embodiment 1. Note that in FIG. 3C, first incidence optical element 32 is presented in a flat shape for easy understanding. FIG. 4 illustrates a state before first light guide body 30 and second light guide body 40 are each molded into an arc shape.

As illustrated in FIG. 3A through FIG. 4, first light guide body 30 is light guide body 10 for extending, in first direction D1, an image presented by image light emitted by image light emitter 20. First direction D1 is a direction along a curve that is arc-shaped. An axis along first direction D1 is partly orthogonal to the optical axis of the image light emitted by image light emitter 20.

First light guide body 30 is light guide body 10 that extends along first direction D1, and the cross section of first light guide body 30 when viewed along its lateral direction is arc-shaped. First light guide body 30 is fixed to second light guide body 40 to overlap second light guide body 40. First light guide body 30 is disposed so that one end of first light guide body 30 in the lengthwise direction thereof faces emission surface portion 29 of image light emitter 20. First light guide body 30 includes rear surface 30a located on the image light emitter 20 side and front surface 30b that faces against rear surface 30a and is located on the second light guide body 40 side. The thickness of first light guide body 30 is fixed and the curvature radius of rear surface 30a of first light guide body 30 is greater than that of front surface 30b. In other words, first light guide body 30, when viewed from the side, is curved to be protruding on the image light emitter 20 side and recessed on the front window 3 side.

First light guide body 30 includes first light guide plate 31, first incidence optical element 32, and first emission optical element 33. First light guide body 30 is one example of a light guide body, first light guide plate 31 is one example of a light guide plate, and first emission optical element 33 is one example of an optical element.

First light guide plate 31 is a curved light guide plate that is light-transmissive and extends along first direction D1 from the incident surface facing emission surface portion 29 of image light emitter 20. First light guide plate 31 has a cross-section that is arc-shaped when viewed along its lateral direction. First light guide plate 31 includes first incident surface 31a and first emission surface 31b.

Image light emitted from emission surface portion 29 is incident on first incident surface 31a. First incident surface 31a faces emission surface portion 29 and is disposed at a location that is a predetermined distance away from emission surface portion 29. First incident surface 31a is a portion of rear surface 30a of first light guide body 30 and is a surface at one end of first light guide body 30. The light incident on first incident surface 31a enters first incidence optical element 32.

The image light emitted from first emission optical element 33 which is to be described later is emitted from first emission surface 31b toward second light guide body 40. First emission surface 31b faces second light guide body 40 and is disposed in close contact with second light guide body 40. First emission surface 31b is a portion of front surface 30b of first light guide body 30.

Each of first incidence optical element 32 and first emission optical element 33 is an arc-shaped light-transmissive diffractive hologram included in first light guide plate 31. First incidence optical element 32 and first emission optical element 33 are aligned in first direction D1.

First incidence optical element 32 is included in first light guide plate 31 to face first incident surface 31a of first light guide body 30. When overlapped with emission surface portion 29, first incidence optical element 32 has an area larger than that of the emission surface of emission surface portion 29, and covers the emission surface. First incidence optical element 32 diffracts the image light that has entered first incidence optical element 32 from first incident surface 31a, so that the image light is guided inside first light guide body 30 in accordance with diffraction efficiency and enters first emission optical element 33.

First emission optical element 33 has a function to extend incident image light in first direction D1. First emission optical element 33 is included in first light guide plate 31 so that first emission optical element 33 faces first emission surface 31b of first light guide body 30. When overlapped with first emission surface 31b, first emission optical element 33 has an area smaller than that of first emission surface 31b, and is covered by first emission surface 31b. First emission optical element 33 is disposed closer, than first incidence optical element 32 is, to the side on which the guided image light is emitted. First emission optical element 33 is disposed along first emission surface 31b, that is, first direction D1. First emission optical element 33 has a cross section that is arc-shaped when viewed from the side, and has the same curvature irrespective of where in first emission optical element 33.

The image light diffracted by first incidence optical element 32 enters first emission optical element 33. First emission optical element 33 is provided so that angle α relative to a propagation direction (the direction of an arrow that intersects first emission optical element 33) in which the light propagates inside first light guide plate 31 is constant. Angle α is an angle made between the center line of first emission optical element 33 and an axis along the direction of light that propagates inside first light guide plate 31.

First emission optical element 33 diffracts a portion of the image light that has entered (passed through) first emission optical element 33 from a predetermined direction, and emits the diffracted light from first emission surface 31b. The rest of the image light that has not been diffracted by first emission optical element 33 is reflected by front surface 30b or rear surface 30a to be guided inside first light guide body 30, and enters first emission optical element 33 again. First emission optical element 33 diffracts a portion of the rest of the image light and emits the diffracted light from first emission surface 31b. The rest of the image light that has not been diffracted by first emission optical element 33 is reflected by front surface 30b or rear surface 30a to be guided inside first light guide body 30, and enters first emission optical element 33 again. Such incidence, diffraction, emission, and reflection of the image light are repeatedly performed in first light guide body 30. Note that the diffraction efficiency of first emission optical element 33 may be set lower with closeness to first incidence optical element 32 and higher with a distance away from first incidence optical element 32. The image light emitted from first light guide body 30 enters second light guide body 40.

### <Second Light Guide Body 40>

Second light guide body 40 is light guide body 10 for extending, in second direction D2, an image presented by image light emitted by first light guide body 30, to emit the image light. Second direction D2 is the same direction as the lateral direction mentioned above. An axis along second direction D2 is straight and approximately orthogonal to the axis along first direction D1 and the optical axis of the image light emitted by image light emitter 20.

Second light guide body 40 is light guide body 10 that extends along first direction D1 and second direction D2, and has a cross section that is arc-shaped when viewed along its lateral direction. First light guide body 30 is fixed so that second light guide body 40 overlaps first light guide body 30. Second light guide body 40 is disposed so that one end of second light guide body 40 in the lengthwise direction thereof faces first light guide body 30. Second light guide body 40 includes rear surface 40a located on the first light guide body 30 side and front surface 40b that faces against rear surface 40a and is located on the front window 3 side. The thickness of second light guide body 40 is fixed and the curvature radius of rear surface 40a of second light guide body 40 is greater than that of front surface 40b.

Second light guide body 40 includes second light guide plate 41, second incidence optical element 42, and second emission optical element 43. Second light guide body 40 is one example of a light guide body, second light guide plate 41 is one example of a light guide plate, and second emission optical element 43 is one example of an optical element.

Second light guide plate 41 is a light guide plate that is light-transmissive and extends along first direction D1 and second direction D2. Second light guide plate 41 has a cross section that is arc-shaped when viewed along its lateral direction, that is, second direction D2. Second light guide plate 41 includes second incident surface 41a and second emission surface 41b.

The image light emitted from first emission surface 31b of first light guide plate 31 is incident on second incident surface 41a. Second incident surface 41a faces first emission surface 31b and is in close contact with first emission surface 31b. Second incident surface 41a is a portion of rear surface 40a of second light guide body 40 and is a surface at one end of second light guide body 40.

The image light emitted from second emission optical element 43 which is to be described later is emitted from second emission surface 41b toward front window 3. Second emission surface 41b faces front window 3 and is a predetermined distance away from front window 3. Second emission surface 41b is a portion of front surface 40b of second light guide body 40.

Each of second incidence optical element 42 and second emission optical element 43 is an arc-shaped light-transmissive diffractive hologram included in second light guide plate 41. Second incidence optical element 42 and second emission optical element 43 are aligned in second direction D2.

Second incidence optical element 42 is included in second light guide plate 41 so that second incidence optical element 42 faces second incident surface 41a of second light guide body 40. When overlapped with emission surface portion 29, second incidence optical element 42 has an area larger than that of first emission optical element 33 of first light guide body 30, and covers first emission optical element 33. Second incidence optical element 42 diffracts the image light emitted from first emission surface 31b of first light guide body 30 and entered second incidence optical element 42 from second incident surface 41a, so that the image light is guided inside second light guide body 40 in accordance with diffraction efficiency and enters second emission optical element 43.

Second emission optical element 43 has a function to extend incident image light in second direction D2. Second emission optical element 43 is included in second light guide plate 41 so that second emission optical element 43 faces second emission surface 41b of second light guide body 40. When overlapped with second emission surface 41b, second emission optical element 43 has an area smaller than that of second emission surface 41b, and is covered by second emission surface 41b. Second emission optical element 43 is disposed closer, than second incidence optical element 42 is, to the side on which the guided image light is emitted. Second emission optical element 43 is provided to extend along second emission surface 41b, that is, first direction D1 and second direction D2. Second emission optical element 43 has a cross section that is arc-shaped when viewed from the side, and has the same curvature irrespective of where in second emission optical element 43.

The image light diffracted by second incidence optical element 42 and propagated inside second light guide plate 41 enters second emission optical element 43. Every time the image light enters (passes through) second emission optical element 43 from a predetermined direction, second emission optical element 43 diffracts further the image light to emit a portion of the image light from second emission surface 41b via second light guide plate 41. Specifically, a portion of the image light diffracted by second emission optical element 43 is emitted from second emission surface 41b via second light guide plate 41, as well as the rest of the image light is diffracted by second emission optical element 43 and emitted from second emission surface 41b, while being guided inside second light guide body 40. Note that the diffraction efficiency of second emission optical element 43 may be set lower with closeness to second incidence optical element 42 and higher with a distance away from second incidence optical element 42. The image light that has entered second emission optical element 43 is extended in second direction D2 and emitted from second emission surface 41b.

As illustrated in FIG. 3A, emission angle θ1 or θ2 of the light emitted from second emission optical element 43 varies depending on a region of second emission optical element 43 from which the light is emitted. Each of emission angles θ1 and θ2 is an angle relative to a normal (indicated by a dashed line) to the emission surface of second emission optical element 43 serving as a reference. When second emission optical element 43 is divided into a front region and a rear region relative to the position of the user, for example, emission angle θ2 of the rear region is greater than emission angle θ1 of the front region. With such display device 1, the rays of the light emitted from second emission optical element 43 toward front window 3 are approximately parallel to each other irrespective of whether the light is emitted from the front region or the rear region. The expression “approximately parallel” allows for a difference of angle of, for example, a small percentage relative to being parallel in a true sense.

### <Operation>

With such display device 1, light emitted from the light source of image light emitter 20 passes through condenser lens 22, and the entire rear surface of light emission portion 29 is irradiated with the light. Accordingly, image light including an image is emitted from the emission surface which is the front surface of emission surface portion 29.

The image light emitted from the emission surface of image light emitter 20 is incident on first incident surface 31a of first light guide plate 31, guided inside first light guide plate 31, and then enters first incidence optical element 32. The image light that has entered first incidence optical element 32 is diffracted by first incidence optical element 32, guided inside first light guide plate 31, and then enters first emission optical element 33. The image light that has entered first emission optical element 33 is diffracted by first emission optical element 33. A portion of the image light that has entered first emission optical element 33 is guided inside first light guide plate 31 and then emitted from first emission surface 31b. The rest of the image light is guided inside first light guide plate 31 (and then reflected by front surface 30b or rear surface 30a), and after that, enters first emission optical element 33 again. In this way, the diffraction and the emission of a portion of the image light are repeated by first emission optical element 33 so that the image light emitted by image light emitter 20 is extended in first direction D1.

The image light emitted from first emission surface 31b of first light guide body 30 is incident on second incident surface 41a of second light guide plate 41, guided inside second light guide plate 41, and then enters second incidence optical element 42. The image light that has entered second incidence optical element 42 is diffracted by second incidence optical element 42 and enters second emission optical element 43. The image light that has entered second emission optical element 43 is diffracted by second emission optical element 43. A portion of the image light that has entered second emission optical element 43 is guided inside second light guide plate 41 and then emitted from second emission surface 41b. The rest of the image light is guided inside second light guide plate 41 (and then reflected by front surface 40b or rear surface 40a), and after that, enters second emission optical element 43 again. In this way, the diffraction and the emission of a portion of the image light are repeated by second emission optical element 43 so that the image light emitted by first light guide body 30 is extended in second direction D2. In other words, second emission optical element 43 emits the image light of an image enlarged by extending, to first direction D1 and second direction D2, the image presented by the image light emitted by image light emitter 20.

The image light emitted from second emission optical element 43 is guided inside second light guide plate 41 and emitted from second emission surface 41b of second light guide plate 41. The image light emitted from second emission surface 41b of second light guide plate 41 is incident on and reflected by front window 3, and the image light is emitted toward the user in vehicle 2. The user can therefore see an image which is a virtual image displayed by display device 1 and overlapped with front scenery seen from front window 3 in the traveling direction of vehicle 2.

### Variation 1 of Embodiment 1

Display device 1 according to Variation 1 of Embodiment 1 will be described. Variation 1 describes an example in which light image emitter 20 emits converging light.

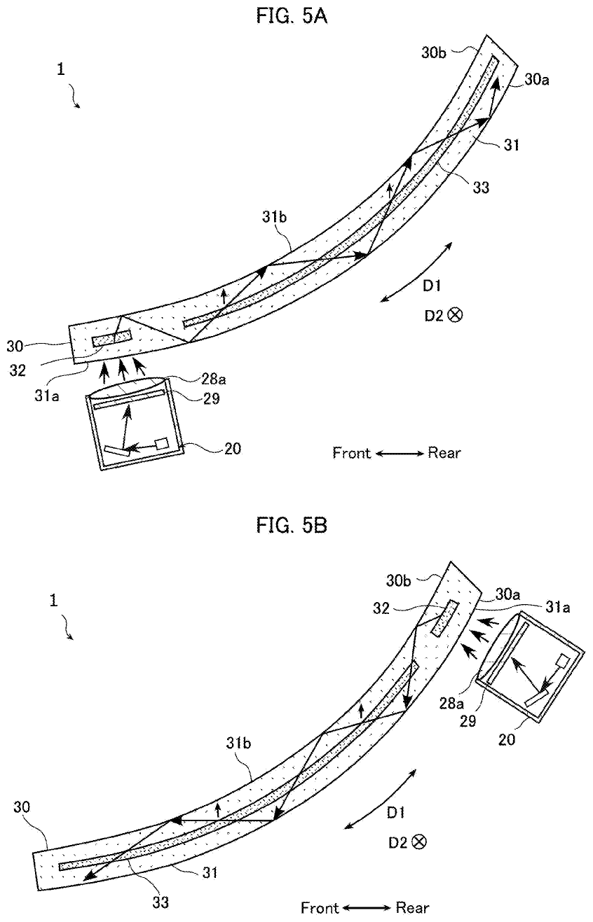

FIG. 5A is a cross-sectional view of display device 1 according to Variation 1 of Embodiment 1 when viewed from the side. Note that FIG. 5A illustrates only image light emitter 20 and first light guide body 30.

Image light emitter 20 in display device 1 according to Variation 1 includes field lens 28a that converges image light. Field lens 28a is a cylindrical lens that converges, in first direction D1, that is, a direction in which first light guide body 30 is curved, image light emitted from emission surface portion 29, and does not converge the image light in second direction D2. Converging light resulting from the image light being converged by filed lens 28a is incident on rear surface 30a (the outer curved surface) of first light guide body 30, that is, first incident surface 31a. First light guide body 30 has front surface 30b and rear surface 30a, and the curvature radius of rear surface 30a is greater than that of front surface 30b. Rays of light having the same angles of incidence relative to first incident surface 31a are incident on first incident surface 31a.

Moreover, image light emitter 20 according to Variation 1 outputs image light toward an edge portion of rear surface 30a of first light guide body 30 in a direction along the curved surface (first direction D1). Specifically, image light emitter 20 outputs converging light to a front edge portion out of edge portions, in the direction along the curved surface, of rear surface 30a of first light guide body 30.

In the present variation, image light output from image light emitter 20 is converging light and enters first light guide body 30 at a fixed angle relative to rear surface 30a of first light guide body 30. Accordingly, it is possible to allow the image light emitted by image light emitter 20 to enter first light guide body 30 at a fixed and appropriate angle, thereby emitting the image light in an appropriate form from first light guide body 30. It is thus possible to show the user an image in an appropriate form using display device 1.

### Variation 2 of Embodiment 1

Display device 1 according to Variation 2 of Embodiment 1 will be described. Variation 2 also describes an example in which image light emitter 20 emits converging light.

FIG. 5B is a cross-sectional view of display device 1 according to Variation 2 of Embodiment 1 when viewed from the side. FIG. 5B illustrates only image light emitter 20 and first light guide body 30.

Image light emitter 20 in display device 1 according to Variation 2 includes field lens 28a that converges image light. Field lens 28a is a cylindrical lens that converges, in first direction D1, that is, a direction in which first light guide body 30 is curved, image light emitted from emission surface portion 29, and does not converge the image light in second direction D2. Converging light resulting from the image light being converged by filed lens 28a is incident on rear surface 30a (the outer curved surface) of first light guide body 30, that is, first incident surface 31a. First light guide body 30 has front surface 30b and rear surface 30a, and the curvature radius of rear surface 30a is greater than that of front surface 30b. Rays of light having the same angles of incidence relative to first incident surface 31a are incident on first incident surface 31a.

Moreover, image light emitter 20 according to Variation 2 outputs image light toward an edge portion of rear surface 30a of first light guide body 30 in a direction along the curved surface (first direction D1). Specifically, image light emitter 20 outputs converging light to a rear edge portion out of edge portions, in the direction along the curved surface, of rear surface 30a of first light guide body 30.

In the present variation, image light output from image light emitter 20 is converging light and enters first light guide body 30 at a fixed angle relative to rear surface 30a of first light guide body 30. Accordingly, it is possible to allow the image light emitted by image light emitter 20 to enter first light guide body 30 at a fixed and appropriate angle, thereby emitting image light in an appropriate form from first light guide body 30. It is thus possible to show the user an image in an appropriate form using display device 1.

### Embodiment 2

The configuration of display device 1a according to Embodiment 2 will be described. In the present embodiment, first incidence optical element 32a, first emission optical element 33a, second incidence optical element 42a, and second emission optical element 43a are of reflection type, which is different from the first incidence optical element, the first emission optical element, the second incidence optical element, and the second emission optical element according to Embodiment 1. The other elements according to Embodiment 2 are same as those described in Embodiment 1 unless otherwise stated, and are assigned with like reference signs so that detailed description regarding the other elements is omitted.

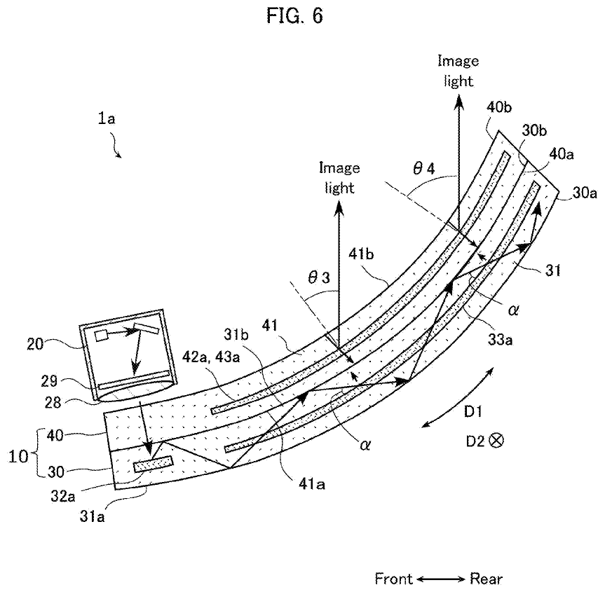

FIG. 6 is a cross-sectional view of display device 1a according to Embodiment 2 when viewed from the side.

First emission optical element 33a according to the present embodiment diffracts a portion of image light that has reflected off front surface 30b of first light guide body 30 and entered first emission optical element 33a, and emits the diffracted light from first emission surface 31b. Moreover, first emission optical element 33a allows the rest of the image light that has not been diffracted to propagate toward rear surface 30a of first light guide body 30. In other words, first emission optical element 33a is a light-reflective diffractive hologram included in first light guide body 30.

First light guide body 30 according to Embodiment 2 is of a curved shape when display device 1a is viewed along its lateral direction. Specifically, first emission optical element 33a is provided in first light guide body 30 so that an angle of first emission optical element 33a relative to a propagation direction (a direction that intersects first emission optical element 33a) in which the light propagates inside first light guide plate 31 is constant irrespective of where in first emission optical element 33a.

In other words, in display device 1a according to Embodiment 2, angle α at which the light propagating inside first light guide plate 31 enters first emission optical element 33a is same irrespective of where in first emission optical element 33a. Accordingly, it is possible, when making first emission optical element 33a, to process a material to be processed while fixing an angle of an irradiation beam with which the material is irradiated and changing a location on the material where the irradiation beam is irradiated. This allows easy making of first emission optical element 33a.

As illustrated in FIG. 6, emission angle θ3 or θ4 of light emitted from second emission optical element 43a varies depending on a region of second emission optical element 43a from which the light is emitted. Each of emission angles θ3 and θ4 is an angle relative to a normal (indicated by a dashed line) to the emission surface of second emission optical element 43a serving as a reference. When second emission optical element 43a is divided into a front region and a rear region relative to the position of the user, for example, emission angle θ4 of the rear region is greater than emission angle θ3 of the front region. With such display device 1a, the rays of the light emitted from second emission optical element 43a toward front window 3 are approximately parallel to each other irrespective of whether the light is emitted from the front region or the rear region.

### Variation 1 of Embodiment 2

Display device 1a according to Variation 1 of Embodiment 2 will be described. Variation 1 of Embodiment 2 describes an example in which image light emitter 20 emits diverging light to front surface 30b of first light guide body 30.

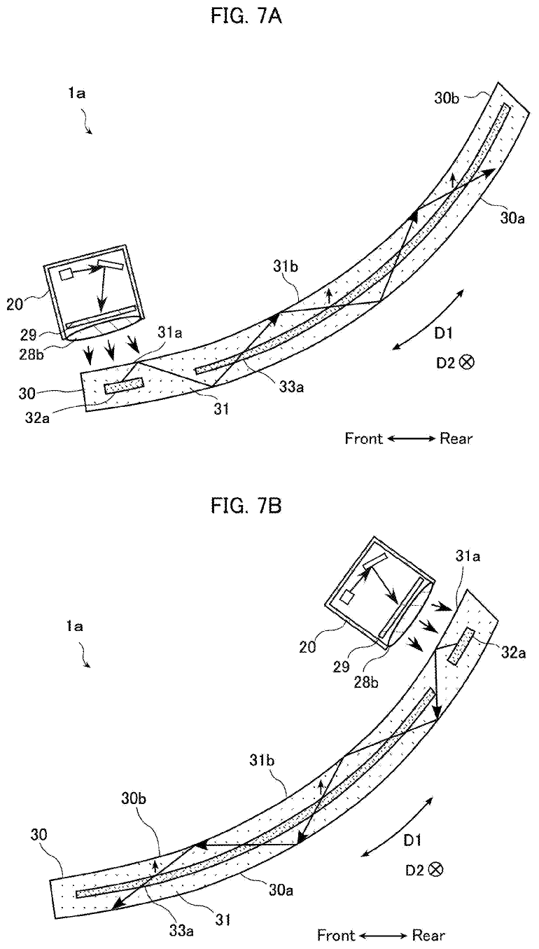

FIG. 7A is a cross-sectional view of display device 1a according to Variation 1 of Embodiment 2 when viewed from the side. FIG. 7A illustrates only image light emitter 20 and first light guide body 30.

Image light emitter 20 in display device 1a according to Variation 1 of Embodiment 2 includes field lens 28b that diverges image light. Field lens 28b is a cylindrical lens that diverges, in first direction D1, that is, a direction in which first light guide body 30 is curved, image light emitted from emission surface portion 29, and does not diverge the image light in second direction D2. The diverging light resulting from the image light being diverged by field lens 28b is incident on front surface 30b (the inner curved surface) of first light guide body 30. First light guide body 30 includes front surface 30b and rear surface 30a, and the curvature radius of front surface 30b is less than that of rear surface 30a. Rays of light having the same angles of incidence relative to first incident surface 31a are incident on first incident surface 31a.

Moreover, image light emitter 20 according to the present variation outputs image light toward an edge portion of rear surface 30a of first light guide body 30 in a direction along the curved surface (first direction D1). Specifically, image light emitter 20 outputs the diverging light to a front edge portion out of edge portions, in the direction along the curved surface, of rear surface 30a of first light guide body 30.

In the present variation, image light output from image light emitter 20 is diverging light and enters first light guide body 30 at a fixed angle relative to rear surface 30a of first light guide body 30. Accordingly, it is possible to allow the image light emitted by image light emitter 20 to enter first light guide body 30 at a fixed and appropriate angle, thereby emitting the image light in an appropriate form from first light guide body 30. It is thus possible to show the user an image in an appropriate form using display device 1a.

### Variation 2 of Embodiment 2

Display device 1a according to Variation 2 of Embodiment 2 will be described. Variation 2 of Embodiment 2 illustrates an example in which image light emitter 20 emits diverging light to front surface 30b of first light guide body 30.

FIG. 7B is a cross-sectional view of display device 1a according to Variation 2 of Embodiment 2 when viewed from the side. FIG. 7B illustrates only image light emitter 20 and first light guide body 30.

Image light emitter 20 in display device 1a according to Variation 2 of Embodiment 2 includes field lens 28b that diverges image light. Field lens 28b is a cylindrical lens that diverges, in first direction D1, that is, a direction in with first light guide 30 is curved, image light emitted from emission surface portion 29, and does not diverge the image light in second direction D2. The diverging light resulting from the image light being diverged by field lens 28b is incident on front surface 30b (the inner curved surface) of first light guide body 30. First light guide body 30 includes front surface 30b and rear surface 30a, and the curvature radius of front surface 30b is less than that of rear surface 30a. Rays of light having the same angles of incidence relative to first incident surface 31a are incident on first incident surface 31a.

Moreover, image light emitter 20 according to the present variation outputs image light toward an edge portion of rear surface 30a of first light guide body 30 in a direction along the curved surface (first direction D1). Specifically, image light emitter 20 outputs the diverging light to a rear edge portion out of edge portions, in the direction along the curved surface, of rear surface 30a of first light guide body 30.

In the present variation, image light output from image light emitter 20 is diverging light, and enters first light guide body 30 at a fixed angle relative to rear surface 30a of first light guide body 30. Accordingly, it is possible to allow the image light emitted by image light emitter 20 to enter first light guide body 30 at a fixed and appropriate angle, thereby emitting the image light in an appropriate form from first light guide body 30. It is thus possible to show the user an image in an appropriate form using display device 1a.

### <Operational Effects>

Next, operational effects of display device 1 according to the embodiment described above will be described.

As described above, display device 1 according to the embodiment includes a light guide body and displays an image of light emitted from the light guide body. The light guide body is of a curved shape, and includes a light guide plate and an optical element that diffracts and emits light propagating inside the light guide plate. The optical element is provided in the light guide body so that an angle of the optical element relative to a propagation direction in which the light propagates inside the light guide plate is constant irrespective of where in the optical element.

Since the light guide body is of a curved shape, it is possible to direct outside light that has reflected off the front surface of the light guide body toward a location different from the location of the user's eyes, and inhibit the outside light from entering the user's eyes. In addition, since an angle at which light propagating inside the light guide plate enters the optical element is fixed irrespective of where in the optical element, it is possible, for example, when making an optical element, to process a material to be processed while fixing an angle of an irradiation beam with which the material is irradiated and changing a location on the material where the irradiation beam is irradiated. This enables easy making of the optical element.

The light guide body may have a cross section that is arc-shaped.

Since the light guide body has a cross section that is arc-shaped, it is possible to direct outside light that has reflected off the front surface of the light guide body to a location different from the location of the user's eyes, and inhibit the outside light from entering the user's eyes. In addition, since the light guide body has an arc-shaped cross section, an angle at which the light propagating inside the light guide plate enters the optical element is fixed irrespective of where in the optical element. It is possible, for example, when making an optical element, to process a material to be processed while fixing an angle of an irradiation beam with which the material is irradiated and changing a location on the material where the irradiation beam is irradiated. This enables easy making of the optical element.

The emission angle of the light emitted from the optical element may vary depending on a region of the optical element from which the light is emitted.

By thus varying the emission angle of the light emitted from the optical element depending on a region of the optical element from which the light is emitted, it is possible to direct the light in the same direction. Accordingly, it is possible to show an image which is a virtual image displayed by display device 1 and overlapped with front scenery seen via a display medium such as front window 3.

The rays of the light emitted from the optical element may be approximately parallel to each other.

Since the rays of light emitted from the optical element are approximately parallel to each other, it is possible to direct the light in the same direction. Accordingly, it is possible to show an image which is a virtual image displayed by display device 1 and overlapped with front scenery seen via a display medium such as front window 3.

Display device 1 may further include image light emitter 20 that outputs image light to the light guide body (e.g., first light guide body 30). Image light emitter 20 may output, as the image light, converging light or diverging light.

Accordingly, it is possible to, for example, allow image light emitted by image light emitter 20 to enter the light guide body appropriately. It is thus possible to show the user an image in an appropriate form using display device 1.

The image light may enter the light guide body (e.g., first light guide body 30) at a fixed angle relative to front surface 30b or rear surface 30a of the light guide body.

By thus allowing the image light to enter the light guide body at a fixed angle relative to front surface 30b or rear surface 30a of the light guide body, it is possible, for example, to emit the image light in an appropriate form from the light guide body. Accordingly, it is possible to show the user an image in an appropriate form using display device 1.

The light guide body (e.g., first light guide body 30) may include front surface 30b and rear surface 30a, and front surface 30b may have a curvature radius less than the curvature radius of rear surface 30a. Image light emitter 20 may output the diverging light toward front surface 30b.

Accordingly, it is possible to allow image light to enter the light guide body at a fixed angle relative to front surface 30b of the light guide body, thereby emitting the image light in an appropriate form from the light guide body. It is thus possible to show the user an image in an appropriate form using display device 1a.

The light guide body (e.g., first light guide body 30) may include front surface 30b and rear surface 30a, and rear surface 30a may have a curvature radius greater than the curvature radius of front surface 30b. Image light emitter 20 may output the converging light toward rear surface 30a.

Accordingly, it is possible to allow image light to enter the light guide body at a fixed angle relative to rear surface 30a of the light guide body, thereby emitting the image light in an appropriate form from the light guide body. It is thus possible to show the user an image in an appropriate form using display device 1.

### Other Variations, Etc.

The above has described the present disclosure based on Embodiments 1 and 2 as well as Variations 1 and 2 of each of Embodiments 1 and 2, but the present disclosure is not limited to, for instance, these Embodiments 1 and 2 as well as Variations 1 and 2.

For example, each of processing units included in the display device according to each of the embodiments and so on is typically realized as an LSI which is an integrated circuit. These circuits may be individually realized as one chip or may be realized as one chip including part or all of the circuits.

Each of the processing units to be realized as an integrated circuit is not limited to an LSI and may be realized as a dedicated circuit or a general-purpose processor. A field programmable gate array (FPGA) which can be programmed after an LSI is manufactured or a reconfigurable processor which can reconfigure connection or setting of circuit cells inside an LSI may be used.

It should be noted that in each of the embodiments and so on, each of the elements may be configured by dedicated hardware or may be realized by executing a software program suitable for the element. Each of the elements may be implemented by a program executor such as a CPU or a processor reading and executing a software program recorded on a recording medium such as a hard disc or a semiconductor memory.

All the numbers used above are exemplary numbers for specifically describing the present disclosure, and numbers for implementing the present disclosure are not limited to the exemplary numbers.

Division of a functional block in each block diagram is an example, and plural functional blocks may be realized as one functional block, one functional block may be divided into plural functional blocks, or part of functions may be transferred to another functional block. Besides, single hardware or software may process, in parallel or by way of time division, functions of plural functional blocks having similar functions.

An order in which steps are executed in a flowchart is an exemplary order for specifically describing the present disclosure, and may be an order other than the order described above. Furthermore, part of the steps described above may be executed at the same time as (in parallel to) the execution of other step(s).

Forms obtained by various modifications to any of the foregoing embodiments that can be conceived by a person skilled in the art as well as forms realized by arbitrarily combining elements and functions in the embodiments within the scope of the essence of the present disclosure are also included in the present disclosure.

While embodiment and variations thereof have been described herein above, it is to be appreciated that various changes in form and detail may be made without departing from the spirit and scope of the present disclosure as presently or hereafter claimed.

Further Information about Technical Background to this Application

The disclosures of the following patent applications each including specification, drawings, and claims are incorporated herein by reference in their entirety: Japanese Patent Application No. 2020-062530 filed on Mar. 31, 2020, and PCT International Application No. PCT/JP2021/000894 filed on Jan. 13, 2021.

### INDUSTRIAL APPLICABILITY

The present disclosure can be used, for example, for mobile bodies such as vehicles.

1. A display device that includes a light guide body and displays an image of light emitted from the light guide body, wherein
the light guide body is of a curved shape, and includes a light guide plate and an optical element that diffracts and emits light propagating inside the light guide plate, and
the optical element is provided in the light guide body, an angle of the optical element relative to a propagation direction in which the light propagates inside the light guide plate being constant irrespective of where in the optical element.

2. The display device according to claim 1, wherein
the light guide body has a cross section that is arc-shaped.

3. The display device according to claim 1, wherein
an emission angle of the light emitted from the optical element varies depending on a region of the optical element from which the light is emitted.

4. The display device according to claim 3, wherein
rays of the light emitted from the optical element are approximately parallel to each other.

5. The display device according to claim 1, further comprising:
an image light emitter that outputs image light to the light guide body, wherein
the image light emitter outputs, as the image light, converging light or diverging light.

6. The display device according to claim 5, wherein
the image light enters the light guide body at a fixed angle relative to a front surface or a rear surface of the light guide body.

7. The display device according to claim 5, wherein
the light guide body includes a front surface and a rear surface, the front surface having a curvature radius less than a curvature radius of the rear surface, and
the image light emitter outputs the diverging light toward the front surface.

8. The display device according to claim 5, wherein
the light guide body includes a front surface and a rear surface, the rear surface having a curvature radius greater than a curvature radius of the front surface, and
the image light emitter outputs the converging light toward the rear surface.
